(19) United States
(12) Patent Application Publication
(10) Pub. No.: US 2025/0171054 A1
(43) Pub. Date: May 29, 2025

(54) RAIL SUPPORT MEMBER, CONVEYANCE DEVICE, AND METHOD OF SUPPORTING RAIL IN CONVEYANCE DEVICE

(71) Applicant: NAKANISHI METAL WORKS CO., LTD., Osaka (JP)

(72) Inventor: Yoshihiro OKAZAKI, Osaka-shi (JP)

(73) Assignee: NAKANISHI METAL WORKS CO., LTD., Osaka (JP)

(21) Appl. No.: 18/962,246

(22) Filed: Nov. 27, 2024

(30) Foreign Application Priority Data
Nov. 28, 2023 (JP) 2023-200431

(51) Int. Cl. B61B 1/00; B65G 35/06

(52) U.S. Cl. CPC B61B 1/00; B65G 35/06

(57) ABSTRACT

A rail support member supports a rail including a left rail and a right rail respectively having a channel shape and guiding left and right running wheels of a movable body, and includes a separately-formed yoke including a left separate body and a right separate body. The left separate body has, integrally therewith, a left receiving portion that receives a lower flange portion of the left rail from below, and the right separate body has, integrally therewith, a right receiving portion that receives a lower flange portion of the right rail from below. The rail support member including the separately-formed yoke can be easily installed as a second rail support member between first rail support members adjacent to each other in a front-rear direction at predetermined intervals, each of the first rail support members including an integrally-formed yoke, and being provided in an existing conveyance device.

### FIELD

The present invention relates to a rail support member for supporting a rail that guides a movable body.

### BACKGROUND

In a conveyance device including a rail laid on a predetermined conveyance path and a movable body movable along the rail, rail support members for supporting the rail are used (see Patent Literature (PTL) 1, for example). A number of the rail support members are installed at predetermined intervals along the conveyance path.

The rail support member of PTL 1 includes a yoke that has an opening on its upper side and is substantially U-shaped when viewed in a conveyance direction, and an installation member for installing the yoke on a floor surface. The rail is located on an upper part of the yoke, and there is, below the rail, a cable support member that is wide in a left-right direction as a horizontal direction perpendicular to the conveyance direction (see FIG. 1 of PTL 1).

### CITATION LIST

### Patent Literature

PTL 1: Japanese Unexamined Patent Application Publication No. 2006-8097

### SUMMARY

### Technical Problem

The predetermined intervals at which the rail support members are installed along the conveyance path are determined by a weight of an object to be conveyed by the movable body. Meanwhile, in automobile manufacturing plants, for example, a trend toward electric vehicles (EVs) requires conveyance of heavy vehicles equipped with large batteries. It is desirable to utilize an existing conveyance device for conveying such heavy objects, in order to reduce costs.

However, when an object with heavy weight is conveyed using the existing conveyance device in which the rail support members are installed at the predetermined intervals, as disclosed in PTL 1, the rail supported by the rail support members may be unable to withstand the weight and may deform.

An object of the present invention is to provide a rail support member suitable for conveyance of heavy objects by using an existing conveyance device.

### Solution to Problem

A rail support member according to a first aspect of the present invention is a rail support member for supporting a rail that guides a movable body. The rail includes a left rail and a right rail, each of which has a channel form and an opening facing an opening of a remaining one of the left rail and the right rail at a distance, the left rail and the right rail respectively guiding a left running wheel and a right running wheel of the movable body. The rail support member includes a separately-formed yoke having a left separate body and a right separate body. The separately-formed yoke is used in an integrated state by connecting and fixing the left separate body and the right separate body. The left separate body has, integral therewith, a left receiving portion that receives a lower flange portion of the left rail from below. The right separate body has, integral therewith, a right receiving portion that receives a lower flange portion of the right rail from below.

The rail support member according to the first aspect includes the separately-formed yoke including the left separate body and the right separate body. For example, the left separate body is moved rightward from a left side of the left rail, and the right separate body is moved leftward from a right side of the right rail, and the left and right separate bodies are connected and fixed to allow the separately-formed yoke to be used in an integrated state. With this configuration, the rail support member including the separately-formed yoke can be easily installed as a second rail support member between first rail support members adjacent to each other in a front-rear direction at predetermined intervals, each of the first rail support members including an integrally-formed yoke, and being provided in an existing conveyance device.

For example, the existing conveyance device may be for use in a floor conveyor, and the first rail support members may support a wide component, the width of which in the left-right direction may be greater than a distance between the left receiving portion and the right receiving portion. Even in such a situation, the rail support member including the separately-formed yoke can be easily added without removing the wide component supported by the first rail support members. In addition, the existing conveyance device may be for use in an overhead conveyer. Even in such a situation, the rail support member including the separately-formed yoke can be easily added without removing the rail that is supported by the first rail support members and has a width in the left-right direction greater than the distance between the left receiving portion and the right receiving portion.

Accordingly, the second rail support member can be installed between the first rail support members adjacent to each other in the front-rear direction while reducing the number of work steps. In addition, the left receiving portion of the separately-formed yoke supports the left rail from below, and the right receiving portion of the separately-formed yoke supports the right rail from below, thereby preventing deformation of the rail when conveying a heavy object using the existing conveyance device.

A rail support member according to a second aspect of the present invention, in the rail support member of the first aspect, includes: a left holding member that holds an upper flange portion of the left rail from above; and a right holding member that holds an upper flange portion of the right rail from above. The left holding member is attached to the left separate body by a detachable attachment unit, and the right holding member is attached to the right separate body by a detachable attachment unit.

In the rail support member according to the second aspect, the left holding member is attached to the left separate body by the attachment unit while the left rail is supported from below by the left receiving portion of the left separate body, thereby fixing the left rail to the left separate body. The right holding member is attached to the right separate body by the attachment unit while the right rail is supported from below by the right receiving portion of the right separate body, thereby fixing the right rail to the right separate body.

Accordingly, in comparison with a case where the rail support member is fixed to the rail by welding, the number of work steps can be significantly reduced. In particular, the effect of reducing the number of the work steps is even greater when the conveyance device is installed in a paint factory where paint is handled, and thus the welding is prohibited. In other words, when the rail support member is fixed, by welding, to the rail installed in a paint factory, it is necessary to remove the rail and perform the welding work outside a building of the factory.

In addition, the left receiving portion integral with the left separate body supports the left rail from below, and the right receiving portion integral with the right separate body supports the right rail from below. With this configuration, the rail support member can stably and reliably bear a load applied to the rail that guides the movable body, and a reference height of the rail can be kept at a bottom surface of the rail.

In a rail support member according to a third aspect of the present invention in the rail support members according to the first aspect or the second aspect of the present invention, a shape of the left separate body and a shape of the right separate body are identical.

In the rail support member according to the third aspect, the left and right separate bodies constituting the separately-formed yoke of the rail support member have the identical shape. Therefore, the left separate body and the right separate body are interchangeable, and components can be standardized, thereby reducing manufacturing costs and component-management costs.

In a rail support member according to a fourth aspect of the present invention in the rail support members according to the first aspect or the second aspect of the present invention, the left separate body and the right separate body are bolted together while being overlapped in a front-rear direction.

In the rail support member according to the fourth aspect, the left and right separate bodies constituting the separately-formed yoke of the rail support member are bolted together in a state where they are overlapped in the front-rear direction. Accordingly, rigidity of the separately-formed yoke can be increased, so that the yoke is less likely to deform when conveying heavy objects.

A conveyance device according to a fifth aspect of the present invention is for use in a floor conveyer, and includes: a rail laid on a predetermined conveyance path; and a movable body movable along the rail. The rail includes a left rail and a right rail, each of which has a channel form and an opening facing an opening of a remaining one of the left rail and the right rail at a distance, the left rail and the right rail respectively guiding a left running wheel and a right running wheel of the movable body. The rail is supported by: first rail support members, each of the first rail support members having a yoke; and a second rail support member including a separately-formed yoke, the second rail support member being the rail support member according to the aspect 1 or the aspect 2. Each of the yoke and the separately-formed yoke in a state where separate parts are assembled together has an opening on an upper side thereof, and is substantially U-shaped when viewed in a front-rear direction. The rail is located in an upper part of the yoke of the first rail support member and an upper part of the separately-formed yoke in the state where the separate parts are assembled together, and a wide component that has a width in a left-right direction greater than a distance between the left receiving portion and the right receiving portion is provided below the rail. While the rail is supported by the first rail support members, the left separate body and the right separate body are separated from each other, and then connected and fixed to each other to install the second rail support member between the first rail support members adjacent to each other in the front-rear direction.

In the conveyance device according to the fifth aspect, which includes the rail support member according to the first aspect, the second rail support member including the separately-formed yoke can be easily added, without removing the wide component that is located below the rail supported by the first rail support members and has the width in the left-right direction greater than the distance between the left receiving portion and the right receiving portion.

Accordingly, the second rail support member can be installed between the first rail support members adjacent to each other in the front-rear direction while reducing the number of work steps. In addition, the left receiving portion of the separately-formed yoke supports the left rail from below, and the right receiving portion of the separately-formed yoke supports the right rail from below, thereby preventing deformation of the rail when conveying a heavy object using an existing conveyance device.

A conveyance device according to a sixth aspect of the present invention is for use in an overhead conveyer, and includes: a rail laid on a predetermined conveyance path; and a movable body movable along the rail. The rail includes a left rail and a right rail, each of which has a channel form and an opening facing an opening of a remaining one of the left rail and the right rail at a distance, the left rail and the right rail respectively guiding a left running wheel and a right running wheel of the movable body. The rail is supported by: first rail support members, each of the first rail support members having a yoke; and a second rail support member including a separately-formed yoke, the second rail support member being the rail support member according to the aspect 1 or the aspect 2. Each of the yoke and the separately-formed yoke in a state where separate parts are assembled together has an opening on a lower side thereof, and is substantially inverted U-shaped when viewed in a front-rear direction. The rail is located in a lower part of the yoke of the first rail support member and a lower part of the separately-formed yoke in the state where the separate parts are assembled together. While the rail is supported by the first rail support members, the left separate body and the right separate body are separated from each other, and then connected and fixed to each other to install the second rail support member between the first rail support members adjacent to each other in the front-rear direction.

In the conveyance device according to the six aspect, which includes the rail support member according to the first aspect, the second rail support member including the separately-formed yoke can be easily added, without removing the rail that is supported by the first rail support members and has the width in the left-right direction greater than the distance between the left receiving portion and the right receiving portion.

Accordingly, the second rail support member can be installed between the first rail support members adjacent to each other in the front-rear direction while reducing the number of work steps. In addition, the left receiving portion of the separately-formed yoke supports the left rail from below, and the right receiving portion of the separately-formed yoke supports the right rail from below, thereby preventing deformation of the rail when conveying a heavy object using an existing conveyance device.

In the conveyance devices according to the fifth and sixth aspects, which include the rail support member according to the second aspect, the left holding member is attached to the left separate body by the attachment unit while the left rail is supported from below by the left receiving portion of the left separate body, thereby fixing the left rail to the left separate body. In addition, the right holding member is attached to the right separate body by the attachment unit while the right rail is supported from below by the right receiving portion of the right separate body, thereby fixing the right rail to the right separate body.

Accordingly, in comparison with a case where the rail support member is fixed to the rail by welding, the number of work steps can be significantly reduced. In particular, the effect of reducing the number of the work steps is even greater, when the conveyance device is installed in a paint factory where paint is handled, and thus the welding is prohibited. In other words, when the rail support member is fixed, by welding, to the rail installed in a paint factory, it is necessary to remove the rail and perform the welding work outside a building of the factory.

Furthermore, the left receiving portion integral with the left separate body supports the left rail from below, and the right receiving portion integral with the right separate body supports the right rail from below. With this configuration, the rail support member can stably and reliably bear a load applied to the rail that guides the movable body, and the reference height of the rail can be kept at a bottom surface of the rail.

A method of supporting a rail in the conveyance device according to a seventh aspect of the present invention is a method of supporting a rail in a conveyance device for use in a floor conveyer, the conveyance device including: a rail laid on a predetermined conveyance path; and a movable body movable along the rail. The method includes: adding a rail support member to the conveyance device that has been installed. The rail includes a left rail and a right rail, each of which has a channel form and an opening facing an opening of a remaining one of the left rail and the right rail at a distance, the left rail and the right rail respectively guiding a left running wheel and a right running wheel of the movable body. The rail is supported by a yoke that has an opening on an upper side thereof and is substantially U-shaped when viewed in a front-rear direction. The rail is located on an upper part of the yoke. A wide component is provided below the rail and has a width in a left-right direction greater than a distance between a left receiving part and a right receiving part of a second rail support member including a separately-formed yoke, the second rail support member being the rail support member according to the aspect 1 or the aspect 2. The second rail support member including the separately-formed yoke is additionally installed between first rail support members adjacent to each other in the front-rear direction in the conveyance device that has been installed.

In the method of supporting the rail in the conveyance device according to the seventh aspect, which includes the rail supporting member according to the first aspect, the second rail support member including the separately-formed yoke can be easily added, without removing the wide component that is located below the rail supported by the first rail support members and has the width in the left-right direction greater than the distance between the left receiving portion and the right receiving portion.

Accordingly, the second rail support member can be installed between the first rail support members adjacent to each other in the front-rear direction while reducing the number of work steps. In addition, the left receiving portion of the separately-formed yoke supports the left rail from below, and the right receiving portion of the separately-formed yoke supports the right rail from below, thereby preventing deformation of the rail when conveying a heavy object using an existing conveyance device.

A method of supporting a rail in the conveyance device according to an eighth aspect of the present invention is a method of supporting a rail in a conveyance device for use in an overhead conveyer, the conveyance device including: a rail laid on a predetermined conveyance path; and a movable body movable along the rail. The method includes: adding a rail support member to the conveyance device that has been installed. The rail includes a left rail and a right rail, each of which has a channel form and an opening facing an opening of a remaining one of the left rail and the right rail at a distance, the left rail and the right rail respectively guiding a left running wheel and a right running wheel of the movable body. The rail is supported by a yoke that has an opening on a lower side thereof and is substantially inverted U-shaped when viewed in a front-rear direction. The rail is located on a lower part of the yoke. A second rail support member including the separately-formed yoke is additionally installed between first rail support members adjacent to each other in the front-rear direction in the conveyance device that has been installed, the second rail support member being the rail support member according to the aspect 1 or the aspect 2.

In the method of supporting the rail in the conveyance device according to the eighth aspect, which includes the rail supporting member according to the first aspect, the second rail support member including the separately-formed yoke can be easily added, without removing the rail that is supported by the first rail support members and has the width in the left-right direction greater than the distance between the left receiving portion and the right receiving portion.

Accordingly, the second rail support member can be installed between the first rail support members adjacent to each other in the front-rear direction while reducing the number of work steps. In addition, the left receiving portion of the separately-formed yoke supports the left rail from below, and the right receiving portion of the separately-formed yoke supports the right rail from below, thereby preventing deformation of the rail when conveying a heavy object using an existing conveyance device.

In the method of supporting the rail in the conveyance device according to the seventh aspect or the eighth aspect, which includes the rail support member according to the second aspect, the left holding member is attached to the left separate body by the attachment unit while the left rail is supported from below by the left receiving portion of the left separate body, thereby fixing the left rail to the left separate body. In addition, the right holding member is attached to the right separate body by the attachment unit while the right rail is supported from below by the right receiving portion of the right separate body, thereby fixing the right rail to the right separate body.

Accordingly, in comparison with a case where the rail support member is fixed to the rail by welding, the number of work steps can be significantly reduced. In particular, the effect of reducing the number of the work steps is even greater when the conveyance device is installed in a paint factory where paint is handled, and thus the welding is prohibited. In other words, when the rail support member is fixed, by welding, to the rail installed in a paint factory, it is necessary to remove the rail and perform the welding work outside a building of the factory.

In addition, the left receiving portion integral with the left separate body supports the left rail from below, and the right receiving portion integral with the right separate body supports the right rail from below. With this configuration, the rail support member can stably and reliably bear a load applied to the rail that guides the movable body, and the reference height of the rail can be kept at a bottom surface of the rail.

### Advantageous Effects

As described above, according to the rail support member of the present invention, a rail support member suitable for conveyance of heavy objects by using an existing conveyance device can be provided. Therefore, a conveyance device of the present invention, which uses the rail support member of the present invention, and a rail supporting method in the conveyance device of the present invention are also suitable for the conveyance of heavy objects by using an existing conveyance device.

### BRIEF DESCRIPTION OF DRAWINGS

FIG. 1 is a front view with a partial cross-sectional view, showing an example in which a conveyance device according to an embodiment of the present invention is used in a floor conveyor.

FIG. 2 is an enlarged view of an area enclosed by an alternate long and short dash line in FIG. 1.

FIG. 3 is a perspective view with a partial vertical cross section, showing first rail support members, a second rail support member, and a rail in the example of FIG. 1.

FIG. 4 is a cross-sectional view of the first rail support member at a rear side in FIG. 3, viewed from a front.

FIG. 5 is a cross-sectional view of the second rail support member in FIG. 3, viewed from the front.

FIG. 6 is an exploded perspective view of the second rail support member in FIG. 3.

FIG. 7 is a perspective view showing vertical cross-sections of first rail support members, a second rail support member, and a rail in another embodiment.

FIG. 8 is a cross-sectional view of the first rail support member at a rear side in FIG. 7, viewed from a front.

FIG. 9 is a cross-sectional view of the second rail support member in FIG. 7, viewed from the front.

FIG. 10 is an exploded perspective view of the second rail support member in FIG. 7.

FIG. 11 is a perspective view showing cross-sections of the first rail support members, the second rail support member, and the rail, etc., in an example in which the conveyance device according to the embodiment of the present invention is used in an overhead conveyor.

FIG. 12 is a cross-sectional view of the first rail support member in FIG. 11, viewed from the front.

FIG. 13 is a cross-sectional view of the second rail support member in FIG. 11, viewed from the front.

FIG. 14 is an exploded perspective view of the second rail support member in FIG. 11.

### DESCRIPTION OF EMBODIMENTS

Hereinafter, embodiments according to the present invention are described with reference to the drawings.

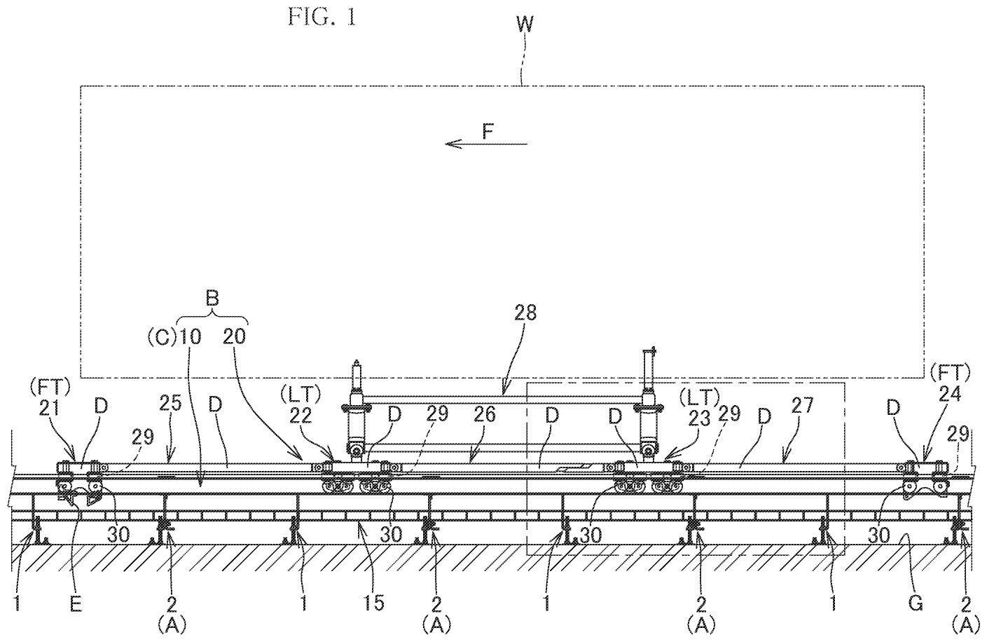

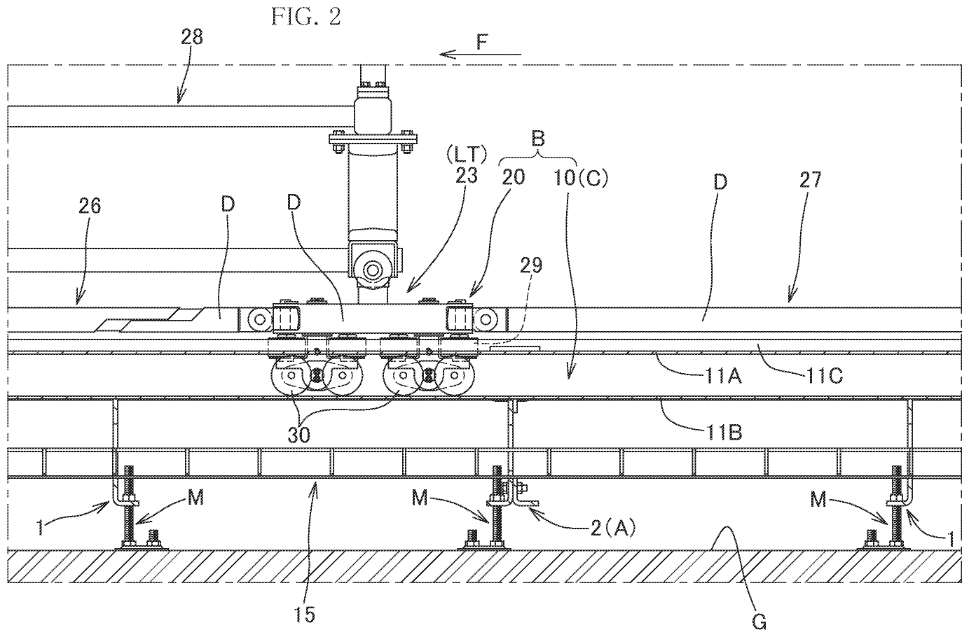

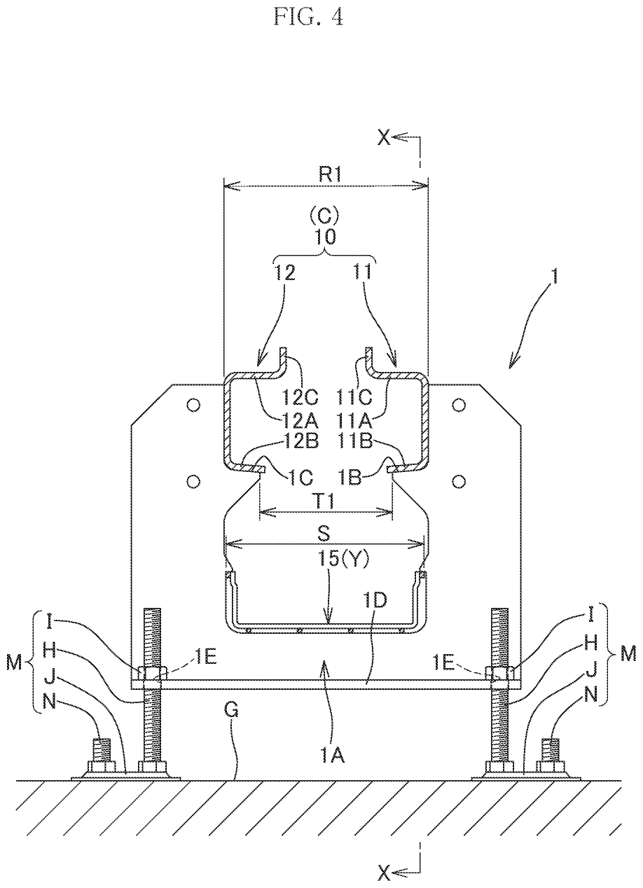

In the description of the specification, a front side (downstream side) along a conveyance direction (see, an arrow F in FIG. 1, for example) is referred to as a front, a rear side (upstream side) as a rear, and left and right are defined facing the front. A view seen from the left is defined as a front view. The front views with the respective partial cross-sectional views of FIGS. 1 and 2 each show a cross section taken along the line X-X in FIG. 4.

### [Conveyance Device]

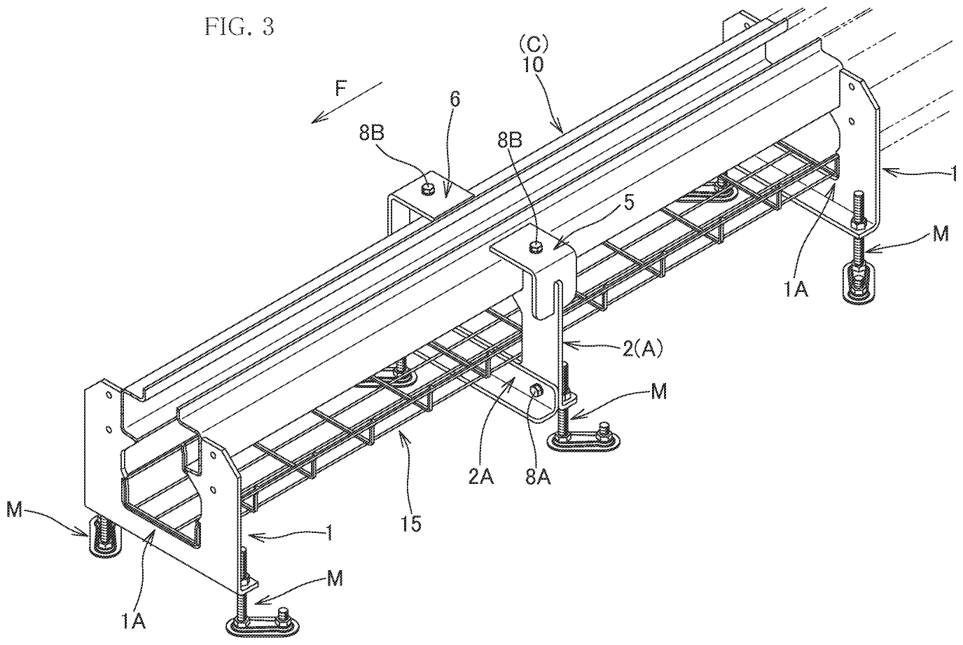

FIGS. 1 and 2 show an example in which a conveyance device B according to the embodiment of the present invention is used in a floor conveyor. FIG. 3 shows first rail support members 1, a second rail support member 2, a rail 10, and the like in the example shown in FIG. 1.

The conveyance device B includes the rail 10 laid on a predetermined conveyance path C, and a movable body 20 movable along the rail 10. The conveyance device B also includes, as rail support members for supporting the rail 10, first rail support members 1 each of which has an integrally-formed yoke 1A and a second rail support member 2 that has a separately-formed yoke 2A. The second rail support member 2 is a rail support member A that can be easily added to an existing conveyance device.

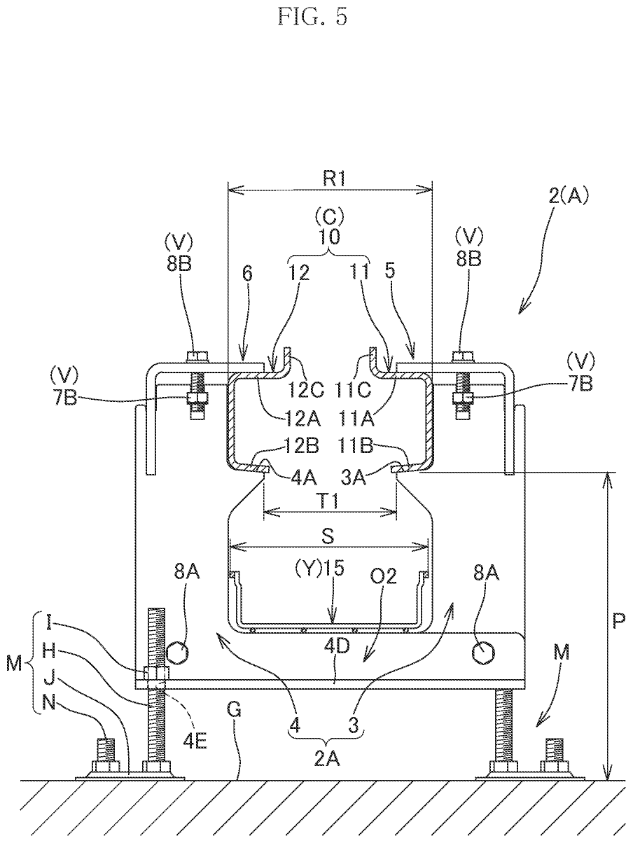

As shown in FIG. 4, the first rail support member 1 has the integrally-formed yoke 1A that has an opening on its upper side and is substantially U-shaped when viewed in a front-rear direction. As shown in FIG. 5, the second rail support member 2 has a separately-formed yoke 2A that has an opening on its upper side and is substantially U-shaped when viewed in the front-rear direction in a state where separate parts of the yoke 2A are assembled together.

The rail 10 is located on an upper part of each of the yoke 1A and the yoke 2A that has the separate form but is in an integrated state. There is a cable support member 15 below the rail 10.

A left-right width S of the cable support member 15 is greater than a distance T1 between a left receiving portion 1B and a right receiving portion 1C of the yoke 1A, and a distance T1 between a left receiving portion 3A and a right receiving portion 4A of the yoke 2A in a state shown in FIG. 5 in which a left separate body 3 and a right separate body 4 are connected and fixed (S>T1).

Accordingly, the cable support member 15 is an example of a wide component Y whose left-right width S is greater than the distance T1 between the left receiving portion 3A and the right receiving portion 4A.

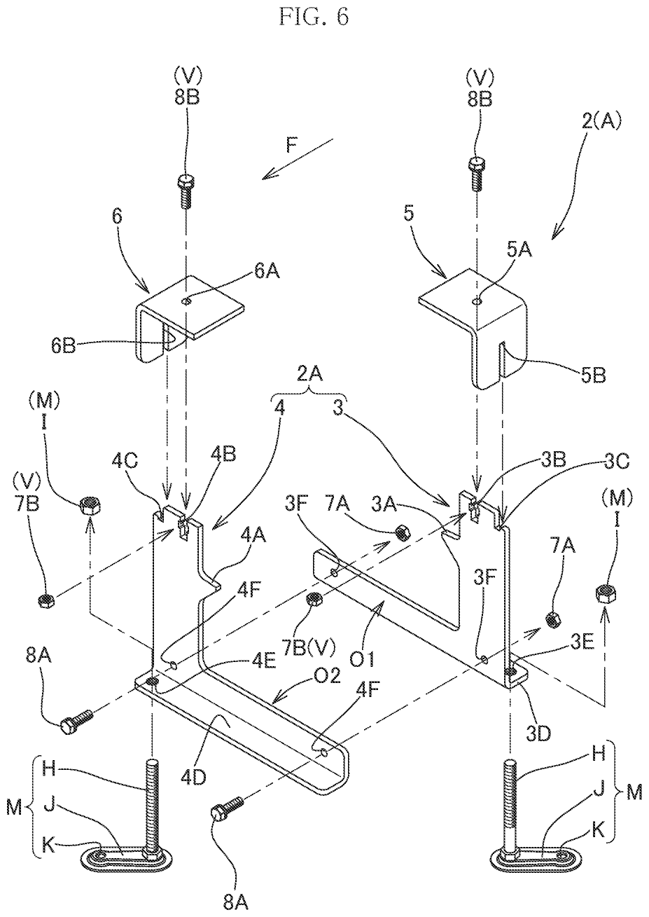

In the conveyance device B, the left and right separate bodies 3 and 4 are connected and fixed as shown in FIG. 5 from a state in which the left separate body 3 and the right separate body 4 are separated as shown in FIG. 6, while the rail 10 is supported by the first rail support member 1 as shown in FIG. 4. Accordingly, the second rail support member 2 is installed between the first rail support members 1 adjacent to each other in the front-rear direction, as shown in FIG. 3.

### [Rail]

As shown in FIGS. 4 and 5, the rail 10 includes channel-shaped left rail 11 and right rail 12 with openings facing each other at a distance from each other, which guide vertical rollers 30 (FIGS. 1 and 2) that are left and right running wheels of the mobile body 20. The rail 10 is laid at a distance above a floor surface G using the first rail support members 1 and the second rail support member 2.

The left rail 11 has an upper flange portion 11A, a lower flange portion 11B, and an upwardly bent edge portion 11C extending upward from an inner end of the upper flange portion 11A in the left-right direction. The right rail 12 has an upper flange portion 12A, a lower flange portion 12B, and an upwardly bent edge portion 12C extending upward from an inner end of the upper flange portion 12A in the left-right direction.

### [Movable Body]

The movable body 20 shown in FIGS. 1 and 2 includes an object support unit 28 that supports an object W to be conveyed, load trolleys LT that support the object support unit 28, and free trolleys FT that do not support the object support unit 28. The load trolleys LT and the free trolleys FT are supported and guided by the rail 10.

The movable body 20 includes trolleys 21, 22, 23, and 24, and connection rods 25, 26, and 27, for example. A front end trolley 21 and a rear end trolley 24 are the free trolleys FT, and a front trolley 22 and a rear trolley 23 are the load trolleys LT.

The front end trolley 21 and the front trolley 22 are connected via the first connection rod 25. The front trolley 22 and the rear trolley 23 are connected via the second connection rod 26. The rear trolley 23 and the rear end trolley 24 are connected via the third connection rod 27.

Every load trolley LT and free trolley FT is equipped with horizontal rollers 29 and vertical rollers 30 that are running wheels. The front and rear horizontal rollers 29 of each of the load trolley LT and the free trolley FT are sandwiched between the left and right bent edge portions 11C and 12C shown in FIGS. 2, 4 and 5. The vertical rollers 30 that are the left and right running wheels of the load trolley LT and the free trolley FT roll on the left and right lower flange portions 11B and 12B shown in FIGS. 2, 4, and 5.

The front end trolley 21 has an engagement dog E that engages with a traction dog of a power chain drive device. This configuration allows the movable body 20 to be driven by the power chain drive device.

The trolleys 21, 22, 23, 24 and the connection rods 25, 26, 27 each have side surfaces that serve as driving surfaces D with which friction rollers of friction roller drive devices are in pressure contact one by one. With this configuration, the movable body 20 can be driven by the friction roller drive device.

### [First Rail Support Member]

The first rail support member 1 shown in FIG. 4 includes an integrally-formed yoke 1A that supports the rail 10, and installation members M for installing the yoke 1A on the floor surface G.

### (Installation of First Rail Support Member on Floor Surface by Installation Member)

Each of the installation members M includes a height adjustment bolt H, a nut I, an anchor plate J, and an anchor bolt N. A height of the yoke 1A is adjusted while the height adjustment bolt H is screwed from below into a screw hole 1E provided in a flange portion 1D extending horizontally from a lower end of the yoke 1A. Subsequently, the nut I is screwed onto an upper end of the height adjustment bolt H to fix the height adjustment bolt H to the yoke 1A. The first rail support member 1 is fixed to the floor surface G by fixing the anchor plate J to the floor surface G using the anchor bolt N.

### (Attachment of Rail to Yoke of First Rail Support Member)

The yoke 1A of the first rail support member 1 includes, for example, the left receiving portion 1B that receives the lower flange portion 11B of the left rail 11 from below, and the right receiving portion 1C that receives the lower flange portion 12B of the right rail 12 from below.

As described above, in FIG. 4, a width R1 of the rail 10 is greater than a distance T1 between the left receiving portion 1B and the right receiving portion 1C (R1>T1). With the left rail 11 being placed on the left receiving portion 1B and the right rail 12 being placed on the right receiving portion 1C, the yoke 1A and the rail 10 are fixed together by, for example, welding.

The yoke 1A and the rail 10 are firmly fixed to each other by, for example, welding, so that the left receiving portion 1B and the right receiving portion 1C are not essential components. Here, with the yoke 1A having the left receiving portion 1B and the right receiving portion 1C, the left receiving portion 1B and the right receiving portion 1C receive a load of the rail 10, and the rail 10 can be positioned in a vertical direction while the rail 10 is supported by the yoke 1A as shown in FIG. 4. Therefore, it is more preferable that the yoke 1A is provided with the left receiving portion 1B and the right receiving portion 1C.

### [Second Rail Support Member]

The second rail support member 2, shown in FIGS. 5 and 6, serves as the rail support member A that can be easily added to an existing conveyance device. The second rail support member 2 includes the separately-formed yoke 2A that supports the rail 10, and installation members M for installing the yoke 2A on the floor surface G.

The yoke 2A of the second rail support member 2 has the left receiving portion 3A that receives the lower flange portion 11B of the left rail 11 from below, and the right receiving portion 4A that receives the lower flange portion 12B of the right rail 12 from below. That is, in FIG. 5, the width R1 of the rail 10 is greater than the distance T1 between the left receiving portion 1B and the right receiving portion 1C (R1>T1).

The separately-formed yoke 2A includes a left separate body 3 and a right separate body 4, and is used in a state where the left separate body 3 and the right separate body 4 are connected and fixed as shown in FIG. 5. The yoke 2A has an opening on its upper side and is substantially U-shaped when viewed in the front-rear direction, so that the left separate body 3 and the right separate body 4 are each substantially L-shaped when viewed in the front-rear direction, as shown in FIG. 6.

The left separate body 3 has, integrally therewith, the left receiving portion 3A that receives the lower flange portion 11B of the left rail 11 from below. The right separate body 4 has, integrally therewith, the right receiving portion 4A that receives the lower flange portion 12B of the right rail 12 from below.

### (Connection and Fixation of Left and Right Separate Bodies)

FIGS. 5 and 6 are referred to. A height of an upper surface of the left receiving portion 3A of the left separate body 3 is made lower than a height of a lower surface of the lower flange portion 11B of the left rail 11, and a height of an upper surface of a rightward extension portion O1 in a lower portion of the left separate body 3 is made lower than a height of a lower surface of the cable support member 15. A height of an upper surface of the right receiving portion 4A of the right separate body 4 is made lower than a height of a lower surface of the lower flange portion 12B of the right rail 12, and a height of an upper surface of a leftward extension portion O2 in a lower portion of the right separate body 4 is made lower than a height of a lower surface of the cable support member 15. In this state, the left separate body 3 is moved rightward from a left side of the left rail 11, and the right separate body 4 is moved leftward from a right side of the right rail 12.

While the leftward extension portion O2 of the right separate body 4 and the rightward extension portion O1 of the left separate body 3 are overlapped front to back so that through holes 4F of the right separate body 4 and through holes 3F of the left separate body 3 are aligned, bolts 8A are each inserted into the corresponding one of the through holes 4F and 3F and the respective nuts 7A are screwed in, thereby connecting and fixing the left separate body 3 and the right separate body 4 to allow the separately-formed yoke 2A to be used in an integrated form.

In this manner, the left separate body 3 and the right separate body 4 which constitute the separately-formed yoke 2A of the second rail support member 2 are bolted together in a state where they are overlapped in the front-rear direction. Accordingly, rigidity of the separately-formed yoke 2A can be increased, so that the yoke 2A is less likely to deform when conveying heavy objects.

### (Installation of Second Rail Support Member on Floor Surface by Installation Member)

Each of the installation members M includes a height adjustment bolt H, a nut I, an anchor plate J, and an anchor bolt N. Before the left separate body 3 and the right separate body 4 are connected and fixed, the height adjustment bolt H is screwed into a screw hole 3E provided in a flange portion 3D extending horizontally from a lower end of the left separate body 3, and another height adjustment bolt H is screwed into a screw hole 4E provided in a flange portion 4D extending horizontally from a lower end of the right separate body 4.

After the left separate body 3 and the right separate body 4 are connected and fixed, a height of the yoke 2A is adjusted using the height adjustment bolts H so that the lower flange portion 11B of the left rail 11 is supported by the left receiving portion 3A of the left separate body 3, and the lower flange portion 12B of the right rail 12 is supported by the right receiving portion 4A of the right separate body 4. After adjusting the height of the yoke 2A using the height adjustment bolts H, each nut I is screwed onto the corresponding upper end of the height adjustment bolt H to fix each of the height adjustment bolts H to the yoke 2A. Each anchor bolt N is embedded through the corresponding anchor bolt hole K of each of the anchor plates J, thereby fixing the second rail support member 2 to the floor surface G.

In a state where the rail 10 is supported by the yoke 2A having the left receiving portion 3A and the right receiving portion 4A as shown in FIG. 5, the rail 10 can be positioned in the vertical direction.

### (Fixation of Rail to Second Rail Support Member)

FIGS. 5 and 6 are referred to. The second rail support member 2 includes a left holding member 5 that holds the upper flange portion 11A of the left rail 11 from above, and a right holding member 6 that holds the upper flange portion 12A of the right rail 12 from above.

In a state where a nut 7B is engaged with a nut engagement portion 3B of the left separate body 3, a cutout portion 5B of the left holding member 5 is aligned with a cutout portion 3C of the left separate body 3. A bolt 8B is inserted into a through hole 5A of the left holding member 5 to be screwed into the nut 7B, thereby bolting the left holding member 5 to the left separate body 3. With this configuration, the left rail 11 is fixed to the left separate body 3.

In a state where a nut 7B is engaged with a nut engagement portion 4B of the right separate body 4, a cutout portion 6B of the right holding member 6 is aligned with a cutout portion 4C of the right separate body 4. A bolt 8B is inserted into a through hole 6A of the right holding member 6 to be screwed into the nut 7B, the right holding member 6 is bolted to the right separate body 4. With this configuration, the right rail 12 is fixed to the right separate body 4.

In the present embodiment, the nut 7B and the bolt 8B on the left side form a detachable attachment unit V for attaching the left holding member 5 to the left separate body 3, and the nut 7B and the bolt 8B on the right side form a detachable attachment unit V for attaching the right holding member 6 to the right separate body 4. Each of the detachable attachment unit V is not limited to the bolting using the nuts 7B and the bolts 8B, but may be any unit capable of detachably attaching the left holding member 5 to the left separate body 3 and the right holding member 6 to the right separate body 4.

The detachable attachment unit V may include, for example, a unit in which an attachment member having a substantially transversely-laid U-shape when viewed in the front-rear or left-right direction is attached to the left separate body 3 and the right separate body 4, and may also include a rivet and the like that need to be broken when removing the left and right holding members 5 and 6 respectively from the left and right separate bodies 3 and 4.

As described above, with the left rail 11 being supported from below by the left receiving portion 3A of the left separate body 3, the left holding member 5 is attached to the left separate body 3 by the detachable attachment unit V, thereby fixing the left rail 11 to the left separate body 3. Furthermore, with the right rail 12 being supported from below by the right receiving portion 4A of the right separate body 4, the right holding member 6 is attached to the right separate body 4 by another detachable attachment unit V, thereby fixing the right rail 12 to the right separate body 4.

With this configuration, the number of work steps can be significantly reduced, in comparison with a case where the second rail support member 2 is fixed to the rail 10 by welding. In particular, the effect of reducing the number of the work steps is even greater, when the conveyance device B is installed in a paint factory where paint is handled, and thus the welding is prohibited. In other words, when the second rail support member 2 is fixed, by welding, to the rail 10 installed in the paint factory, it is necessary to remove the rail 10 and perform the welding work outside a building of the factory.

In addition, the left receiving portion 3A integral with the left separate body 3 supports the left rail 11 from below, and the right receiving portion 4A integral with the right separate body 4 supports the right rail 12 from below. With this configuration, the second rail support member 2 can stably and reliably bear a load applied to the rail 10 that guides the movable body 20, and a reference height P of the rail 10 shown in FIG. 5 can be kept at a bottom surface of the rail 10.

### [Example of Another Embodiment of First and Second Rail Support Members]

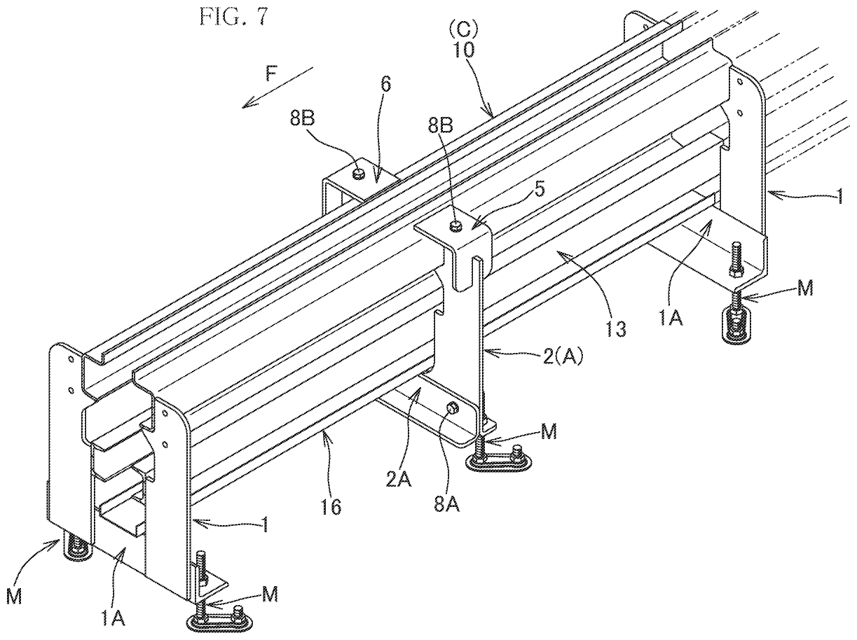

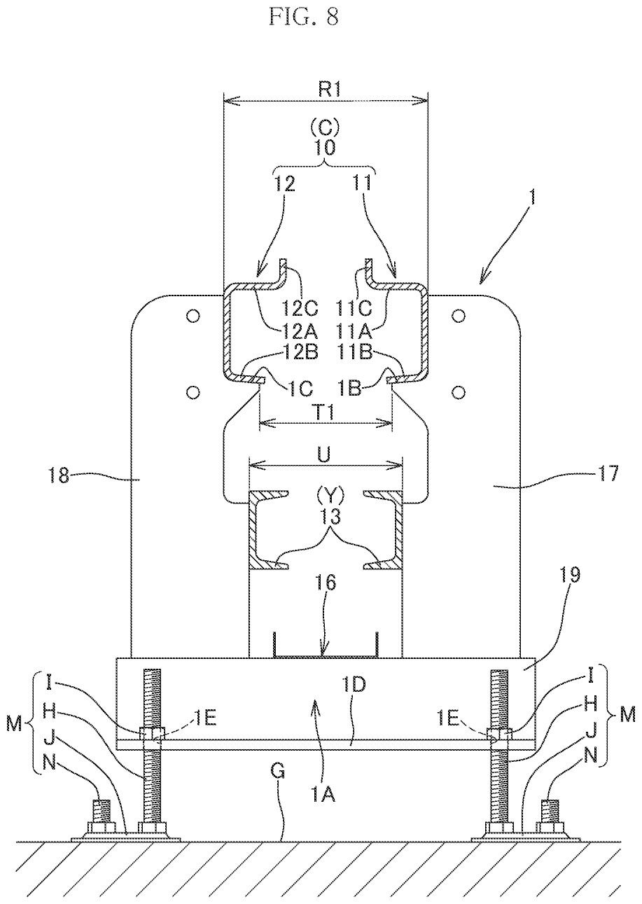

FIGS. 7 to 10 show an example of another embodiment of the first rail support member 1 and the second rail support member 2 serving as the rail support member A that can be easily added to an existing conveyance device. In FIGS. 7 to 10, the same reference signs as those in FIGS. 3 to 6 denote the same or corresponding components or parts, and detailed description thereof will be omitted. The yoke 1A of the first rail support member 1 shown in FIGS. 7 and 8 is formed by integrating a left plate member 17, a right plate member 18, and a lower angle member 19 by welding.

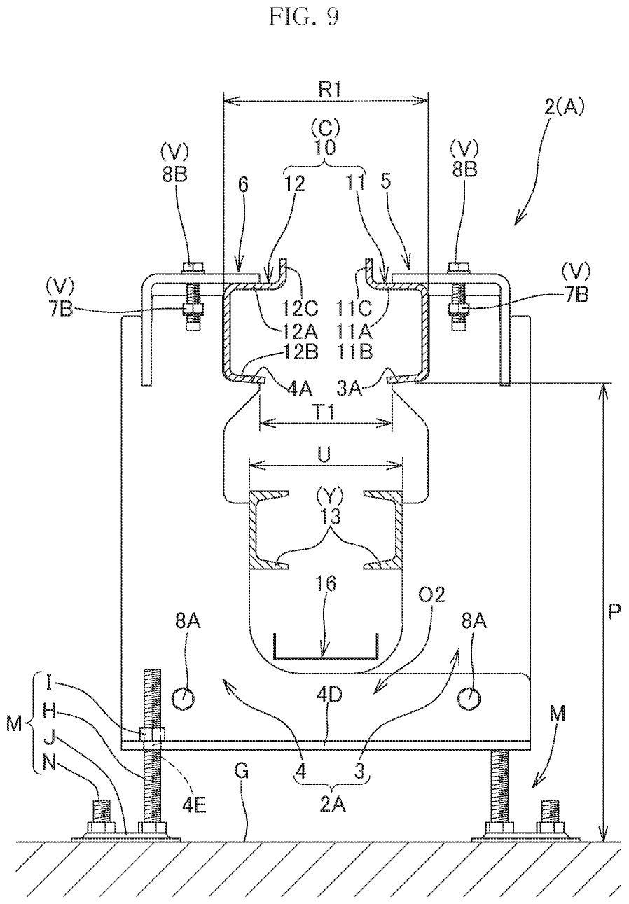

As shown in FIGS. 8 and 9, the first rail support member 1 and the second rail support member 2 respectively have the yokes 1A and 2A that are substantially U-shaped when viewed in the front-rear direction. The rail 10 is located in an upper part of each of the yoke 1A and the yoke 2A that has a separate form, but is in an integrated state. Below the rail 10, there are a power rail 13 and an oil receiver 16. The power rail 13 includes, for example, left and right rails in a channel shape with openings facing each other at a distance from each other, and guides a power chain of a power chain drive device.

The power rail 13 abuts against an inner surface of the yoke 1A and an inner surface of the yoke 2A, and thus can be positioned in the left-right direction relative to the yokes 1A and 2A.

The width U of the power rail 13 is greater than the distance T1 between the left receiving portion 1B and the right receiving portion 1C of the yoke 1A shown in FIG. 8, and the distance T1 between the left receiving portion 3A and the right receiving portion 4A of the yoke 2A when the left separate body 3 and the right separate body 4 are connected and fixed as shown in FIG. 9 (U>T1).

Accordingly, the power rail 13 is an example of a wide component Y whose left-right width U is greater than the distance T1 between the left receiving portion 3A and the right receiving portion 4A.

In the example shown in FIGS. 8 and 9, there is the power rail 13 that guides the power chain below the rail 10. Accordingly, a vertical length of each of the yokes 1A and 2A in the example of FIGS. 8 and 9 is longer than a vertical length of each of the yokes 1A and 2A in the example of FIGS. 4 and 5.

[Reason for Keeping Rail Height from Floor Low]

Each of the rails 10 shown in FIGS. 4 and 5 as well as FIGS. 8 and 9 is kept low in height from the floor surface G. This is because a height of a ceiling in a building in which the conveyance device B for a floor conveyor is installed is restricted, and thus the conveyance device B should be prevented from interfering with the ceiling when the conveyance object W to be conveyed by the convenance device B is large.

As described above, the height of the rail 10 from the floor surface G is kept low. In the second rail support member 2 in FIGS. 5 and 9, the left separate body 3 is moved from the left side of the left rail 11 to the right side, and the right separate body 4 is moved from the right side of the right rail 12 to the left side, thereby allowing the left separate body 3 and the right separate body 4 to be connected and fixed. Thus, the separately-formed yoke 2A can be integrated. In other words, work can be performed from the outside of the rail 10 in the left-right direction, the height of which is kept low, whereby excellent workability can be obtained.

### [Method of Adding Rail Support Member to Existing Conveyance Device to be Used in Floor Conveyor]

In existing conveyance devices, the second rail support member 2 in FIGS. 1 and 2, for example, is eliminated, and a number of the first rail support members 1 spaced apart in the front-rear direction support the rail 10. As shown in FIGS. 4 and 5, as well as FIGS. 8 and 9, there are the respective wide components Y whose widths S and U in the left-right direction are greater than the distance T1 between the left receiving portion 3A and the right receiving portion 4A of the second rail support member 2 including the separately-formed yoke 2A.

Due to such structural constraints, if the yoke of the second rail support member 2 has an integral form rather than the separate form as in the yoke 2A, the second rail support member 2 cannot be added to the existing conveyance device. However, the yoke 2A of the second rail support member 2 has the separate form as described above. Accordingly, the second rail support member 2 can be additionally installed between the first rail support members 1 adjacent to each other in the front-rear direction in the existing conveyance device to form the conveyance device B shown in FIGS. 1 and 2.

Therefore, the second rail support member 2 can be installed between the first rail support members 1 adjacent to each other in the front-rear direction while reducing the number of work steps. In addition, the left receiving portion 3A of the separately-formed yoke 2A supports the left rail 11 from below, and the right receiving portion 4A of the separately-formed yoke 2A supports the right rail 12 from below. Therefore, deformation of the rail 10 can be prevented when conveying heavy objects using the existing conveyance device.

[Example in which Conveyance Device is Used for Overhead Conveyor]

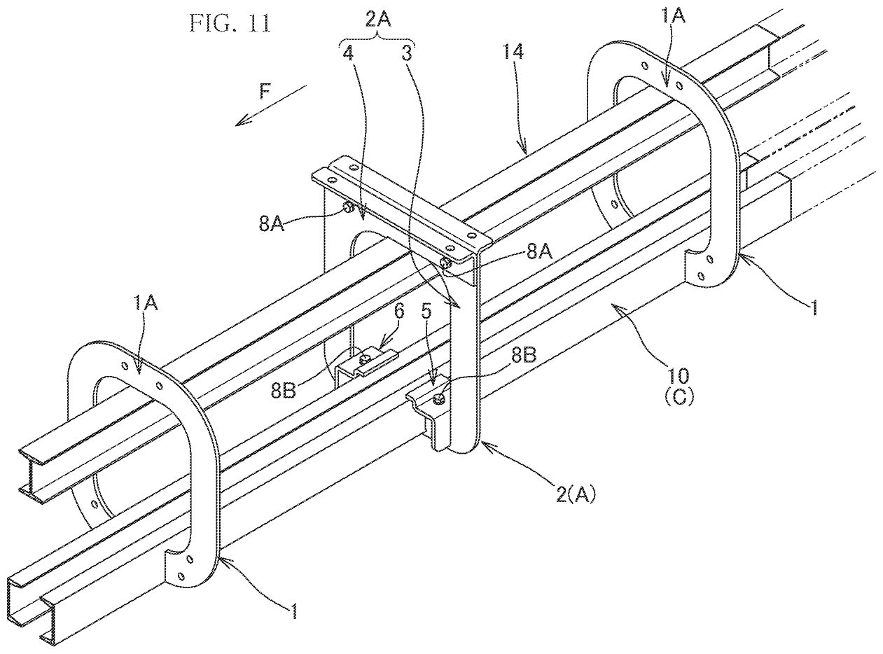

FIGS. 11 to 14 show an example in which the conveyance device according to the embodiment of the present invention is used in an overhead conveyor. The conveyance device includes a rail 10 laid on a predetermined conveyance path C and a movable body capable of moving along the rail 10. In FIGS. 11 to 14, the same reference signs as those in FIGS. 3 to 6 denote the same or corresponding components or parts, and detailed description thereof will be omitted.

The first rail support member 1 includes the yoke 1A having an integral form and an installation member for installing the yoke 1A on a support structure such as an auxiliary beam installed under a ceiling of a building. In addition, a second rail support member 2 serving as the rail support member A that can be easily added to an existing conveyance device, includes a yoke 2A having a separate form and an installation member for installing the yoke 2A to the support structure. In FIGS. 11 to 14, the support structure and the installation members are omitted.

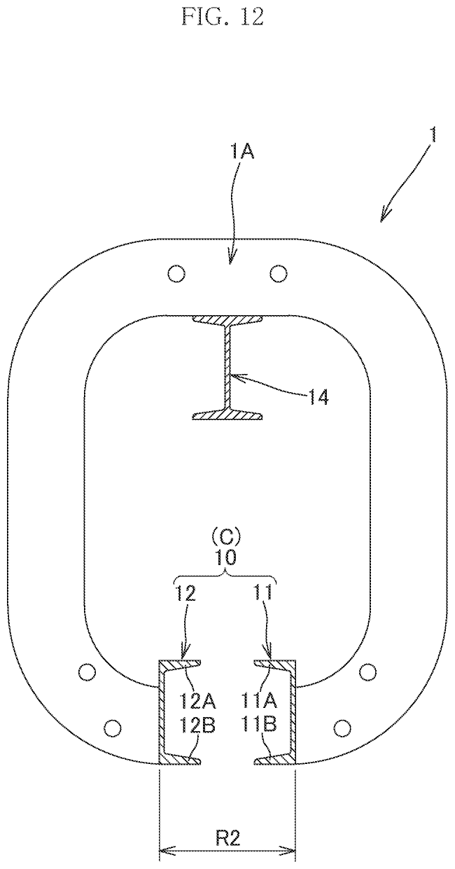

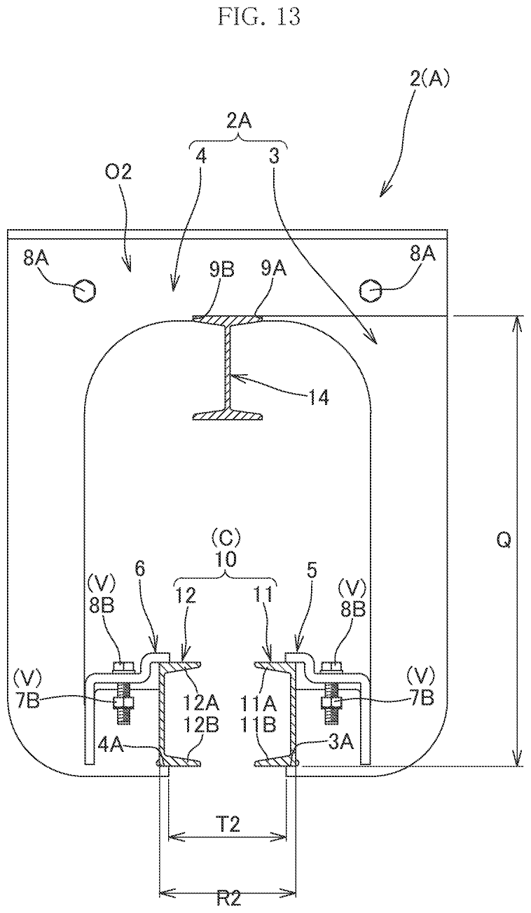

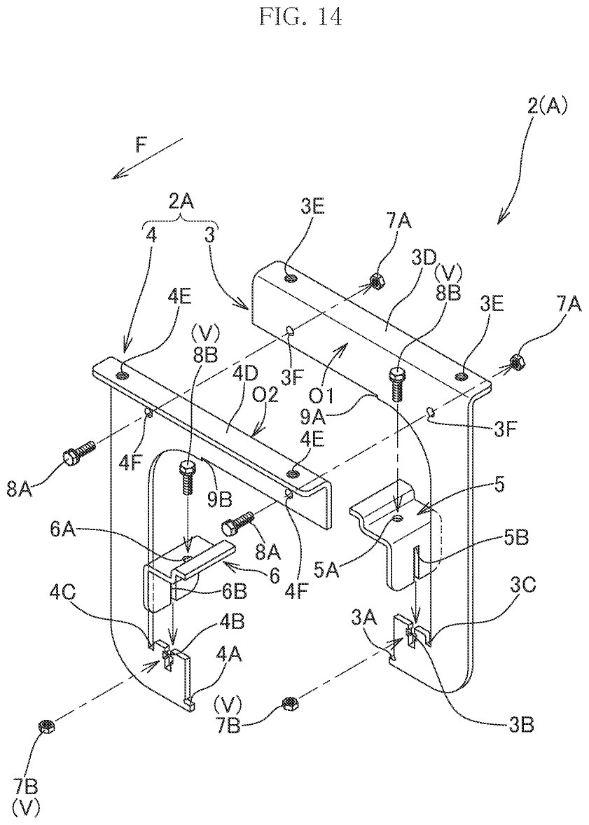

As shown in FIG. 12, the first rail support member 1 has the integrally-formed yoke 1A having an opening on its lower side, and is substantially inverted U-shaped when viewed in the front-rear direction. As shown in FIG. 13, the second rail support member 2 has a separately-formed yoke 2A having an opening on its lower side, and is substantially inverted U-shaped when viewed in the front-rear direction when separated parts of the yoke 2A are assembled together. As shown in FIG. 14, the left separate body 3 and the right separate body 4 of the separately-formed yoke 2A of the second rail support member 2 each have a substantially inverted L-shape when viewed in the front-rear direction.

The rail 10 is located in a lower part of each of the yoke 1A and the yoke 2A that has the separate form, but is in the integrate state. The rail 10 and the yoke 1A are firmly fixed together by, for example, welding.

Above the rail 10, there is a power rail 14. The power rail 14 has, for example, an I-shaped cross section when viewed in the front-rear direction, and guides a power chain of a power chain drive device. The power rail 14 abuts against a step portion 9A of the left separate body 3 and a step portion 9B of the right separate body 4, and therefore can be positioned in the left-right direction with respect to the yoke 2A.

A width R2 of the rail 10 in the left-right direction is greater than a distance T2 between the left receiving portion 3A and the right receiving portion 4A of the yoke 2A in the state shown in FIG. 13 in which the left separate body 3 and the right separate body 4 are connected and fixed (R2>T2).

The conveyance device according to the embodiment of the present invention may be used for an overhead conveyor. Such a conveyance device is configured such that the second rail support member 2 is installed between the first rail support members 1 adjacent to each other in the front-rear direction as shown in FIG. 11, by connecting and fixing the left and right separate bodies 3 and 4 as shown in FIG. 13, from a state where the left and right separate bodies 3 and 4 are separated as shown in FIG. 14, while the rail 10 is supported by the first rail support member 1 as shown in FIG. 12.

The rail 10 can be positioned in the vertical direction by the yoke 2A having the left receiving portion 3A and the right receiving portion 4A, while the rail 10 is supported by the yoke 2A as shown in FIG. 13.

The left rail 11 is bolted to the left separate body 3 by the left holding member 5, and the right rail 12 is bolted to the right separate body 4 by the right holding member 6.

With this configuration, the number of work steps can be significantly reduced, in comparison with a case where the second rail support member 2 is fixed to the rail 10 by welding. In particular, the effect of reducing the number of the work steps is even greater, when the conveyance device is installed in a paint factory where paint is handled, and thus the welding is prohibited. In other words, when the second rail support member 2 is fixed, by welding, to the rail 10 installed in the paint factory, it is necessary to remove the rail 10 and perform the welding work outside a building of the factory.

In addition, the left receiving portion 3A integral with the left separate body 3 supports the left rail 11 from below, and the right receiving portion 4A integral with the right separate body 4 supports the right rail 12 from below. With this configuration, the second rail support member 2 can stably and reliably bear a load received by the rail 10 that guides the movable body of the conveyance device, and a reference height Q of the rail 10 shown in FIG. 13 can be kept at a bottom surface of the rail 10.

### [Method of Adding Rail Support Member to Existing Conveyance Device to be Used in Overhead Conveyor]

In the existing conveyance device used for an overhead conveyor, the support members that support the rail 10 correspond to support members shown in FIG. 11 in which the second rail support member 2, for example, is eliminated and a number of first rail support members 1 spaced apart in the front-rear direction support the rail 10. As shown in FIGS. 12 and 13, the rail 10 has a left-right width R2 that is greater than the distance T2 between the left and right receiving portions 3A and 4A of the second rail support member 2 including the separately-formed yoke 2A.

Due to such structural constraints, if the yoke of the second rail support member 2 has the integral form rather than the separate form as in the yoke 2A, the second rail support member 2 cannot be added to the existing conveyance device. However, the yoke 2A of the second rail support member 2 has the separate form as described above. Accordingly, the second rail support member 2 can be additionally installed between the first rail support members 1 adjacent to each other in the front-rear direction in the existing conveyance device.

Therefore, the second rail support member 2 can be installed between the first rail support members 1 adjacent to each other in the front-rear direction while reducing the number of work steps. In addition, the left receiving portion 3A of the separately-formed yoke 2A supports the left rail 11 from below, and the right receiving portion 4A of the separately-formed yoke 2A supports the right rail 12 from below. Therefore, deformation of the rail 10 can be prevented when conveying heavy objects using the existing conveyance device.

### [Shapes of Left and Right Separate Bodies]

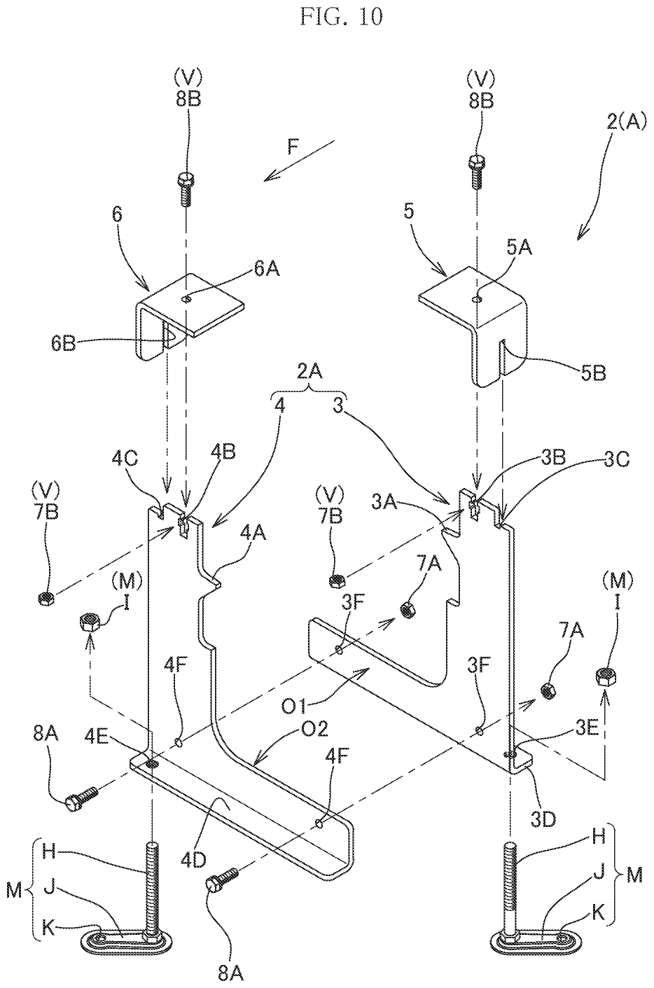

A shape of the left separate body 3 and a shape of the right separate body 4 shown in FIG. 6 are identical. Furthermore, a shape of the left separate body 3 and a shape of the right separate body 4 shown in FIG. 10 are identical. Furthermore, a shape of the left separate body 3 and a shape of the right separate body 4 shown in FIG. 14 are identical. Therefore, the left separate body 3 and the right separate body 4 are interchangeable, and components can be standardized, thereby reducing manufacturing costs and component-management costs.

### [Shapes of Left and Right Holding Members]

A shape of the left holding member 5 and a shape of the right holding member 6, respectively shown in FIGS. 6 and 10, are identical. Furthermore, a shape of the left holding member 5 and a shape of the right holding member 6 shown in FIG. 14 are identical. Therefore, the left holding member 5 and the right holding member 6 are interchangeable, and the components can be standardized, thereby reducing manufacturing costs and component-management costs.

The above description of the embodiments is merely illustrative and the present invention is not limited thereto. Various improvements and changes can be made without departing from the scope of the invention.

1. A rail support member for supporting a rail that guides a movable body, wherein
the rail includes a left rail and a right rail, each of which has a channel form and an opening facing an opening of a remaining one of the left rail and the right rail at a distance, the left rail and the right rail respectively guiding a left running wheel and a right running wheel of the movable body,
the rail support member includes a separately-formed yoke having a left separate body and a right separate body,
the separately-formed yoke is used in an integrated state by connecting and fixing the left separate body and the right separate body,
the left separate body has, integral therewith, a left receiving portion that receives a lower flange portion of the left rail from below, and
the right separate body has, integral therewith, a right receiving portion that receives a lower flange portion of the right rail from below.

2. The rail support member according to claim 1, comprising:
a left holding member that holds an upper flange portion of the left rail from above; and
a right holding member that holds an upper flange portion of the right rail from above, wherein
the left holding member is attached to the left separate body by a detachable attachment unit, and
the right holding member is attached to the right separate body by a detachable attachment unit.

3. The rail support member according to claim 1, wherein
a shape of the left separate body and a shape of the right separate body are identical.

4. The rail support member according to claim 2, wherein
a shape of the left separate body and a shape of the right separate body are identical.

5. The rail support member according to claim 1, wherein
the left separate body and the right separate body are bolted together while being overlapped in a front-rear direction.

6. The rail support member according to claim 2, wherein
the left separate body and the right separate body are bolted together while being overlapped in a front-rear direction.

7. A conveyance device for use in a floor conveyer, the conveyance device comprising:
a rail laid on a predetermined conveyance path; and
a movable body movable along the rail, wherein
the rail includes a left rail and a right rail, each of which has a channel form and an opening facing an opening of a remaining one of the left rail and the right rail at a distance, the left rail and the right rail respectively guiding a left running wheel and a right running wheel of the movable body,
the rail is supported by: first rail support members, each of the first rail support members having a yoke; and a second rail support member including a separately-formed yoke, the second rail support member being the rail support member according to claim 1,
each of the yoke and the separately-formed yoke in a state where separate parts are assembled together has an opening on an upper side thereof, and is substantially U-shaped when viewed in a front-rear direction,
the rail is located in an upper part of the yoke of the first rail support member and an upper part of the separately-formed yoke in the state where the separate parts are assembled together, and a wide component that has a width in a left-right direction greater than a distance between the left receiving portion and the right receiving portion is provided below the rail, and
while the rail is supported by the first rail support members,
the left separate body and the right separate body are separated from each other, and then connected and fixed to each other to install the second rail support member between the first rail support members adjacent to each other in the front-rear direction.

8. A conveyance device for use in an overhead conveyer, the conveyance device comprising:
a rail laid on a predetermined conveyance path; and
a movable body movable along the rail, wherein
the rail includes a left rail and a right rail, each of which has a channel form and an opening facing an opening of a remaining one of the left rail and the right rail at a distance, the left rail and the right rail respectively guiding a left running wheel and a right running wheel of the movable body,
the rail is supported by: first rail support members, each of the first rail support members having a yoke; and a second rail support member including a separately-formed yoke, the second rail support member being the rail support member according to claim 1,
each of the yoke and the separately-formed yoke in a state where separate parts are assembled together has an opening on a lower side thereof, and is substantially inverted U-shaped when viewed in a front-rear direction,
the rail is located in a lower part of the yoke of the first rail support member and a lower part of the separately-formed yoke in the state where the separate parts are assembled together, and
while the rail is supported by the first rail support members,
the left separate body and the right separate body are separated from each other, and then connected and fixed to each other to install the second rail support member between the first rail support members adjacent to each other in the front-rear direction.

9. A method of supporting a rail in a conveyance device for use in a floor conveyer, the conveyance device including: a rail laid on a predetermined conveyance path; and a movable body movable along the rail,
the method comprising:
adding a rail support member to the conveyance device that has been installed, wherein
the rail includes a left rail and a right rail, each of which has a channel form and an opening facing an opening of a remaining one of the left rail and the right rail at a distance, the left rail and the right rail respectively guiding a left running wheel and a right running wheel of the movable body,
the rail is supported by a yoke that has an opening on an upper side thereof and is substantially U-shaped when viewed in a front-rear direction,
the rail is located on an upper part of the yoke,
a wide component is provided below the rail and has a width in a left-right direction greater than a distance between a left receiving part and a right receiving part of a second rail support member including a separately-formed yoke, the second rail support member being the rail support member according to claim 1, and
the second rail support member including the separately-formed yoke is additionally installed between first rail support members adjacent to each other in the front-rear direction in the conveyance device that has been installed.

10. A method of supporting a rail in a conveyance device for use in an overhead conveyer, the conveyance device including: a rail laid on a predetermined conveyance path; and a movable body movable along the rail,
the method comprising:
adding a rail support member to the conveyance device that has been installed, wherein
the rail includes a left rail and a right rail, each of which has a channel form and an opening facing an opening of a remaining one of the left rail and the right rail at a distance, the left rail and the right rail respectively guiding a left running wheel and a right running wheel of the movable body,
the rail is supported by a yoke that has an opening on a lower side thereof and is substantially inverted U-shaped when viewed in a front-rear direction,
the rail is located on a lower part of the yoke, and
a second rail support member including the separately-formed yoke is additionally installed between first rail support members adjacent to each other in the front-rear direction in the conveyance device that has been installed, the second rail support member being the rail support member according to claim 1.
